(19) United States
(12) Patent Application Publication
(10) Pub. No.: US 2026/0066460 A1
(43) Pub. Date: Mar. 5, 2026

(54) ELECTRODE ASSEMBLIES, AND PREPARATION METHODS THEREOF, AND RECHARGEABLE LITHIUM BATTERIES

(71) Applicant: SAMSUNG SDI CO., LTD., Yongin-si (KR)

(72) Inventors: Hosung YANG, Yongin-si (KR); Duckjae YOU, Yongin-si (KR); Changwon PARK, Yongin-si (KR); Jiye WOO, Yongin-si (KR)

(73) Assignee: SAMSUNG SDI CO., LTD., Yongin-si (KR)

(21) Appl. No.: 19/315,214

(22) Filed: Aug. 29, 2025

(30) Foreign Application Priority Data
Sep. 2, 2024 (KR) 10-2024-0118662

(51) Int. Cl. H01M 50/426; H01M 10/052; H01M 50/42; H01M 50/434; H01M 50/44; H01M 50/443; H01M 50/449

(52) U.S. Cl. CPC H01M 50/426; H01M 10/052; H01M 50/42; H01M 50/434; H01M 50/44; H01M 50/443; H01M 50/449

(57) ABSTRACT

Disclosed are an electrode assembly, a method of preparing the electrode assembly, and a rechargeable lithium battery including the electrode assembly. The electrode assembly includes an electrode current collector, an electrode active material layer on the electrode current collector, and a coating layer located on the electrode active material layer and integrated with the electrode active material layer. The coating layer includes polymer nanofibers. The polymer nanofibers include a fluorine-based polymer and a nitrile-based polymer as a polymer. A dielectric constant of the polymer is greater than or equal to about 0.06 pF/mm³, and the electrical conductivity of the polymer is in a range of about 3.0 μS/mm³ to about 50.0 μS/mm³.

### CROSS-REFERENCE TO RELATED APPLICATION

This application claims priority to Korean Patent Application No. 10-2024-0118662, filed on Sep. 2, 2024 in the Korean Intellectual Property Office, the entire disclosure of which is incorporated herein by reference.

### BACKGROUND

### 1. Field

Electrode assemblies, preparation methods thereof, and rechargeable lithium batteries are disclosed.

### 2. Description of the Related Art

A portable information device such as, e.g., a cell phone, a laptop, a smart phone, and the like, or an electric vehicle, typically uses a rechargeable lithium battery having high energy density and easy portability as a driving power source. Accordingly, rechargeable lithium battery with high energy density as a driving power source or power storage power source for hybrid or electric vehicles may be advantageous.

Rechargeable lithium batteries typically include a positive electrode and a negative electrode including an active material capable of intercalating and deintercalating lithium ions, and an electrolyte solution, and electrical energy is produced through oxidation and reduction reactions when lithium ions are intercalated/deintercalated from the positive electrode and negative electrode.

Transition metal compounds such as, e.g., lithium cobalt-based oxide, lithium nickel-based oxide, and lithium manganese-based oxide are mainly included as positive electrode active materials for rechargeable lithium batteries, and crystalline carbon materials such as natural graphite, artificial graphite or amorphous carbon materials are included as negative electrode active materials.

### SUMMARY

Some example embodiments include an electrode assembly capable of replacing a conventional separator by integrating a coating layer constituting a separator with an electrode active material layer, while exhibiting shutdown characteristics and no heat shrinkage, thereby ensuring desired or improved safety, and a method for manufacturing the same, and a rechargeable lithium battery having desired or improved capacity characteristics and cycle-life characteristics.

Some example embodiments include an electrode assembly including an electrode current collector, an electrode active material layer on the electrode current collector, and a coating layer located on the electrode active material layer and integrated with the electrode active material layer. The coating layer includes polymer nanofibers, and the polymer nanofibers include a fluorine-based polymer and a nitrile-based polymer as a polymer. A dielectric constant of the polymer is greater than or equal to about 0.06 pF/mm³, and electrical conductivity of the polymer is in a range of about 3.0 μS/mm³ to about 50.0 μS/mm³.

In some example embodiments, a method of preparing an electrode assembly includes forming an electrode active material layer on an electrode current collector, introducing a fluorine-based polymer and a nitrile-based polymer into a solvent, and mixing the fluorine-based polymer and the nitrile-based polymer to prepare a polymer solution, performing a heat treatment on the polymer solution at a temperature in a range of about 50° C. to about 150° C. for a duration in a range of about 30 minutes to about 3 hours, and electrospinning the polymer solution onto the electrode active material layer.

In some example embodiments, a rechargeable lithium battery includes the aforementioned electrode assembly.

According to some example embodiments, an electrode assembly is capable of replacing a conventional separator by integrating a coating layer constituting a separator with an electrode active material layer, while having shutdown characteristics and ensuring desired or improved safety due to no heat shrinkage, and a method for preparing the electrode assembly, and a rechargeable lithium battery having desired or improved capacity characteristics and cycle-life characteristics.

### BRIEF DESCRIPTION OF THE DRAWINGS

FIG. 1 to FIG. 4 are cross-sectional views schematically illustrating a rechargeable lithium battery according to some example embodiments.

FIG. 5 illustrates the results of measuring changes in temperature and impedance for rechargeable lithium battery cells prepared in Example 1 and Comparative Example 5.

FIG. 6A and FIG. 6B are images taken using a scanning electron microscope (SEM) of the electrode assembly of Example 1 after the shutdown is applied in Evaluation Example 1.

FIG. 7 is an image of the electrode assembly prepared in Example 1 after heat treatment at 180° C. for 1 hour.

FIG. 8 is an image of the separator included in Comparative Example 5 after heat treatment at 150° C. for 1 hour.

FIG. 9 is an image taken of an electrode assembly manufactured in Example 1 after being immersed in an electrolyte solution, sealed in a pouch, and heat-treated at 150° C. for 1 hour.

FIG. 10 is an image taken of the separator included in Comparative Example 5 after heat treatment at 150° C. for 1 hour.

FIG. 11 is an image taken using a scanning electron microscope (SEM) of the surface of an electrode assembly prepared in Example 1 of Evaluation Example 6.

FIG. 12 illustrates the results of measuring voltage and temperature changes over time after fully charging rechargeable lithium battery cells prepared in Example 1 and Comparative Example 5 and performing heat treatment at 150° C. for 1 hour.

FIG. 13 is a flowchart illustrating a method of preparing an electrode assembly, according to an example embodiment.

### DETAILED DESCRIPTION

Hereinafter, example embodiments are described in detail so that those of ordinary skill in the art can readily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be directly on the other element, or intervening elements may be present therebetween. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of +10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

### Electrode Assembly

Some example embodiments include an electrode assembly including an electrode current collector, an electrode active material layer on the electrode current collector, and a coating layer located on the electrode active material layer and integrated with the electrode active material layer. The coating layer includes polymer nanofibers, the polymer nanofibers include a fluorine-based polymer and a nitrile-based polymer as a polymer. A dielectric constant of the polymer is greater than or equal to about 0.06 pF/mm³, and electrical conductivity of the polymer is in a range of about 3.0 μS/mm³ to about 50.0 μS/mm³.

Rechargeable lithium batteries include a separator between the positive and negative electrodes. Generally, a polyethylene material is included for a separator, but this polyethylene material has a glass transition temperature that is around about −100° C. and a melting point that is around about 110° C., and thus has a challenge of poor heat resistance. In addition, the polyethylene material secures high tensile strength required in a stacking process by orienting polyethylene chains through strong stretching in an MD direction during the manufacturing process. However, because the polyethylene material has low heat resistance and high orientation, the polymer chains tend to return to their original unoriented state at a high temperature, which may cause heat shrinkage and thus make the separator smaller than an electrode plate, resultantly increasing a risk of short circuiting during the cell operation.

Recently, in order to increase energy density of rechargeable lithium batteries, a technology is proposed to manufacture an electrode assembly in which at least either one of a positive electrode active material layer and a negative electrode active material layer is integrated with a coating layer constituting a separator without using a separate separator.

In order to secure a low heat shrinkage rate of the coating layer constituting a separator in the electrode assembly, expensive super engineering plastics such as polyimide (PI), polyether imide (PEI), polyether sulfone (PES), and the like may be used. However, such super engineering plastics may secure the low heat shrinkage rate, but do not secure the shutdown characteristics.

In particular, the coating layer constituting a separator in the electrode assembly may be formed through an electrospinning process and an electrospraying process, but has a challenge of weaker durability than a commercially available separator. Accordingly, in the formation of the coating layer having the separator function, a thermal compression process in addition to the electrospinning process and the electrospraying process may be further performed to secure the durability of the coating layer, but even when such durability could be achieved, an electrode assembly having the shutdown characteristics without heat shrinkage has not been developed yet.

Accordingly, some example embodiments include a coating layer including polymer nanofibers on the surface of an electrode plate to replace a conventional separator and provide an electrode assembly having no heat shrinkage but having shutdown characteristics and thus desired or improved safety.

For example, some example embodiments include controlling dielectric constant and electrical conductivity of a polymer included in the polymer nanofibers within given ranges to improve electrospinning properties, and thus secure a coating layer having shutdown characteristics but no heat shrinkage by using high heat resistance properties of the polymer and the adhesion thereof to the electrode plate. Accordingly, the coating layer that constitutes a separator can hinder or block the passage of lithium ions between the electrode plates by shielding the pores at high temperatures, thereby reducing or suppressing overreaction, thermal explosion, and thermal runaway.

The electrode assembly includes an electrode current collector, an electrode active material layer on the electrode current collector, and a coating layer located on the electrode active material layer and integrated with the electrode active material layer.

When the electrode of the electrode assembly is a positive electrode, the electrode current collector may be or include a positive electrode current collector, and the electrode active material layer may be or include a positive electrode active material layer. When the electrode of the electrode assembly is or includes a negative electrode, the electrode current collector may be or include a negative electrode current collector, and the electrode active material layer may be or include a negative electrode active material layer. Accordingly, the explanation given below regarding the positive and negative electrodes can be applied equally.

### Coating Layer

The coating layer is located on the electrode active material layer and is integrated with the electrode active material layer to constitute a separator. Accordingly, the electrode assembly according to some example embodiments does not require a separate separator and does not require a lamination process for combining the separator and the electrode, so that a battery can be manufactured economically.

The coating layer may be located on the electrode active material layer, and for example, the electrode active material layer may be located between the electrode current collector and the coating layer.

The term “a coating layer integrated with the electrode active material layer” may indicate that a portion of the coating layer located on the electrode active material layer is incorporated into the electrode active material layer and is firmly bonded thereto. According to some example embodiments, when the electrode assembly is observed using a scanning electron microscope (SEM) or the like, the interface between the electrode active material layer and the coating layer may appear to be uneven.

In the case of polyethylene films generally included as a separator, there is a challenge that when exposed to heat, changes in dimensions occur due to heat shrinkage, and the like, which reduces the separation function of the positive and negative electrodes by the separator, possibly resulting in a short circuit.

On the other hand, by using an electrode assembly according to some example embodiments, a coating layer that constitutes a separator is integrated with the electrode active material layer, so that a separate separator is not required, and thus heat shrinkage challenges may not occur, while heat resistance and insulation can be improved and resistance can be reduced.

The coating layer includes polymer nanofibers. For example, the coating layer may have a woven or non-woven structure formed by assembling polymer nanofibers formed by an electrospinning process described below, and preferably may have a non-woven structure. The woven or nonwoven structure formed by this electrospinning process can have high porosity and low tortuosity, which can improve the mobility of lithium ions compared to polyethylene films generally included as separators. In addition, due to the whipping phenomenon caused by the electrospinning process, the polymer nanofibers are not oriented in one direction and thus have isotropy, and due to the multiaxial drawing during the electrospinning process, the polymer chains are not oriented in one direction, so that the relaxation and shrinkage characteristics of the polymer are poor in a high-temperature environment. Accordingly, the woven or non-woven structure can contribute to reducing or suppressing heat shrinkage compared to a separator using polyethylene material.

In the coating layer, the polymer nanofibers include a polymer, and the polymer includes a fluorine-based polymer and a nitrile-based polymer.

The fluorine-based polymer has desired or improved electrochemical safety and binding strength, and thus plays a role in reducing or suppressing side reactions during charging and discharging of rechargeable lithium batteries. The nitrile polymer exhibits desired or improved insulation performance based on desired or improved thermal stability and mechanical safety, and enables rechargeable lithium batteries to operate stably even in high-temperature environments. Accordingly, because the polymer nanofibers include both the fluorine-based polymer and the nitrile-based polymer as polymers, side reactions are reduced or suppressed during charging and discharging of a rechargeable lithium battery, and the rechargeable lithium battery can be stably operated even in a high-temperature environment.

In some example embodiments, the fluorinated polymer may include at least one of polyvinylidene fluoride, polyvinylidene fluoride-hexafluoropropylene, polyvinyl fluoride, polytetrafluoroethylene, or a combination thereof. When this is met, the fluorinated polymer may be advantageous in ensuring safety in high-temperature environments.

For example, the weight average molecular weight (Mw) of the fluorinated polymer may be in a range of about 100,000 g/mol to about 1,500,000 g/mol, about 200,000 g/mol to about 1,300,000 g/mol, or about 300,000 g/mol to about 1,000,000 g/mol. In the above range, side reactions during charging and discharging of rechargeable lithium batteries can be reduced or suppressed, and safety can be effectively substantially secured at high temperatures.

For example, the glass transition temperature (Tg) of the fluorinated polymer may be in a range of about −80° C. to about −5° C., about −50° C. to about −10° C., about −50° C. to about −15° C., or about −40° C. to about −20° C. When this is satisfied, high heat resistance can be readily secured and the occurrence of heat shrinkage can be effectively reduced or suppressed by having a higher glass transition temperature than polyethylene, which is conventionally included as a separator material.

For example, the melting point (Tm) of the fluorinated polymer may be in a range of about 110° C. to about 200° C., about 120° C. to about 200° C., about 130° C. to about 190° C., or about 150° C. to about 180° C. When this is satisfied, high heat resistance can be readily secured and the occurrence of heat shrinkage can be effectively reduced or suppressed by having a higher melting point than polyethylene, which is conventionally included as a separator material.

In some example embodiments, the nitrile polymer may include at least one of polyacrylonitrile, polyacrylonitrile-itaconic acid, polyacrylonitrile-methyl methacrylate, polyacrylonitrile-acrylic acid, polyacrylonitrile-methacrylate, (meth)acrylonitrile-butadiene rubber, or a combination thereof.

For example, the weight average molecular weight (Mw) of the nitrile polymer may be in a range of about 10,000 g/mol to about 1,500,000 g/mol, about 50,000 g/mol to about 1,300,000 g/mol, or about 85,000 g/mol to about 1,000,000 g/mol. In the above range, rechargeable lithium batteries can be operated stably even in high-temperature environments.

For example, the glass transition temperature (Tg) of the nitrile polymer may be in a range of about −80° C. to about 180° C., about −50° C. to about 160° C., about 0° C. to about 150° C., or about 50° C. to about 120° C. When this is satisfied, it can be advantageous in securing high heat resistance and the effect of reducing or suppressing heat shrinkage by having a higher glass transition temperature than polyethylene, which is conventionally included as a separator material, and can also be advantageous in substantially securing shutdown characteristics.

In some example embodiments, the weight ratio of the fluorinated polymer and the nitrile polymer may be in a range of about 1:9 to about 9:1, about 3:7 to about 7:3, or about 5:5 to about 7:3. In the above range, side reactions during charging and discharging of a rechargeable lithium battery can be reduced or suppressed, and the rechargeable lithium battery can be operated stably even in a high-temperature environment.

For example, the diameter of the polymer nanofibers may be in a range of about 10 nm to about 1,000 nm, about 50 nm to about 200 nm, or about 50 nm to about 150 nm. In the above range, a highly porous woven or non-woven structure can be formed, which can improve the mobility of lithium ions.

A dielectric constant of the polymer may be greater than or equal to about 0.06 pF/mm³, and electrical conductivity of the polymer may be in a range of about 3.0 μS/mm³ to about 50.0 μS/mm³. By satisfying the above ranges of dielectric constant and of electrical conductivity of the polymer, the coating layer can secure high heat resistance compared to polyethylene, which is typically included as a separator material, thereby reducing or suppressing the occurrence of heat shrinkage, and can also secure shutdown characteristics by exhibiting the characteristic of melting by reacting with an electrolyte solution in a high-temperature environment.

The shutdown characteristics are capable of hindering or blocking a passage of lithium ions by shielding pores of a separator in a high-temperature environment and reducing or preventing overreaction, thermal explosion, and thermal runaway, and required to secure battery safety. General separators may use materials having a low melting point such as, e.g., polyethylene, which may readily secure the shutdown characteristics due to this melting point. However, the materials with a low melting point such as polyethylene may not be included to form a coating layer that constitutes a separator in an electrode assembly prepared through an electrospinning process, an electrospraying process, and the like, in order to secure high heat resistance. Accordingly, it is technically difficult to achieve the shutdown characteristics as well as secure the high heat resistance.

However, some example embodiments may include a mixture of a fluorine-based polymer and a nitrile-based polymer, which are materials having a higher glass transition temperature and melting point than conventional polyethylene, to secure the high heat resistance and reduce or suppress heat shrinkage, as well as to ensure the shutdown characteristics due to properties of the fluorine-based polymer that the fluorine-based polymer reacts with an electrolyte solution at high temperatures.

For example, dielectric constant of the polymer may be measured by preparing a polymer solution of the fluorine-based polymer and the nitrile-based polymer in a solvent, placing a predetermined volume of the polymer solution on the upper and lower plates of a rheometer, and using a LCR meter within a range of about 50 Hz to about 100000 Hz. For example, the solvent may be or include an organic solvent, and for example, the solvent may include at least one of dimethyl acetate, dimethylformamide, dimethylformaldehyde, dimethyl sulfoxide, N-methylpyrrolidone, ethanol, methanol, chloroform, acetone, water, or a combination thereof.

For example, electrical conductivity of the polymer may also be measured by preparing a polymer solution of the fluorine-based polymer and the nitrile-based polymer in a solvent, placing a predetermined volume of the polymer solution on the upper and lower plates of the rheometer, and using the LCR meter within a range of about 50 Hz to about 100000 Hz. For example, the solvent may be or include an organic solvent, and for example, the solvent may include at least one of dimethyl acetate, dimethylformamide, dimethylformaldehyde, dimethyl sulfoxide, N-methylpyrrolidone, ethanol, methanol, chloroform, acetone, water, or a combination thereof.

In some example embodiments, the coating layer may further include inorganic particles, and the inorganic particles may offset disadvantages of the woven or non-woven structure formed by assembling the polymer nanofibers in the coating layer. The woven or non-woven structure formed by assembling the polymer nanofibers may have high porosity, which may indicate that the electrode active material layer has a high surface area portion which is not in contact with the polymer nanofibers but exposed. The larger exposed area of the electrode active material layer, the more improved mobility of lithium ions, but there is another disadvantage that lithium dendrites may readily grow. The lithium dendrites are one of the causes of short circuits in rechargeable lithium batteries, and thus should be reduced or suppressed. The inorganic particles may physically reduce or suppress growth of the lithium dendrites, contributing to improving safety and cycle-life of the rechargeable lithium batteries.

For example, the inorganic particles may include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. When the inorganic particles are used, the growth of lithium dendrites can be effectively reduced or suppressed.

For example, the average particle diameter (D₅₀) of the inorganic particles may be in a range of about 10 nm to about 1,000 nm, about 50 nm to about 500 nm, or about 150 nm to about 300 nm. When the above particle sizes are satisfied, the inorganic particles can contribute to improving the safety and cycle-life of the battery without hindering the effect of securing high heat resistance and reducing or suppressing heat shrinkage by the polymer nanofibers in the coating layer.

For example, the polymer nanofibers may be included in an amount in a range of about 10 wt % to about 100 wt %, for example, about 20 wt % to about 80 wt %, about 30 wt % to about 60 wt %, or about 40 wt % to about 60 wt % based on 100 wt % of the coating layer. In the above range, the effects of securing high heat resistance and reducing or suppressing heat shrinkage by the polymer nanofibers in the coating layer and the effects of securing safety and improving cycle-life by the inorganic particles can be harmonized with each other.

For example, the inorganic particles may be included in an amount that is less than or equal to about 90 wt %, for example, in a range of about 0 wt % to about 90 wt %, about 20 wt % to about 80 wt %, about 40 wt % to about 70 wt %, or about 40 wt % to about 60 wt % based on 100 wt % of the coating layer. In the above range, the effects of securing high heat resistance and reducing or suppressing heat shrinkage by the polymer nanofibers in the coating layer, and the effects of securing safety and improving cycle-life by the inorganic particles can be harmonized with each other.

In some example embodiments, the coating layer may further include a woven or non-woven structure formed by assembling the polymer nanofibers in the above coating layer; and inorganic particle coating layer including inorganic particles. When this is satisfied, the effects of securing high heat resistance and reducing or suppressing heat shrinkage by the woven or non-woven structure within the coating layer and the effects of securing safety and improving cycle-life by the inorganic particle coating layer can be harmoniously achieved.

For example, the distribution of the inorganic particles may gradually decrease from an upper portion to a lower portion of the coating layer. At this time, the lower portion of the coating layer may represent a surface where the coating layer comes into contact with the electrode active material layer, and the upper portion of the coating layer may represent a surface opposite to the surface where the coating layer comes into contact with the electrode active material layer. When the inorganic particles are distributed on the surface of the electrode active material layer, the inorganic particles can also act as a resistor that inhibits the insertion of lithium ions into the electrode active material layer. Therefore, by performing an electrospraying process using a polymer solution including the fluorine-based polymer and the nitrile-based polymer, followed by an electrospraying process using an inorganic particle solution including the inorganic particles, the distribution of the inorganic particles can exhibit a gradient that gradually decreases from an upper portion to a lower portion of the coating layer. When this is satisfied, the resistance on the surface of the electrode active material layer can be reduced.

For example, the coating layer may have a thickness in a range of about 5 μm to about 40 μm, for example, about 7 μm to about 20 μm, or about 8 μm to about 16 μm. When any of the above ranges are satisfied, the coating layer formed by performing a thermal compression process after the electrospinning process and the electrospraying process may be thinner than a coating layer formed by the electrospinning process and the electrospraying process alone, resultantly ensuring high energy density as well as securing safety.

For example, the ratio of the thickness of the coating layer to the thickness of the electrode active material layer may be in a range of about 1:1 to about 1:50, about 1:1.5 to about 1:40, about 1:2 to about 1:30, or about 1:2.5 to about 1:20. In this range, the effects of ensuring safety and shut-down characteristics by the coating layer, and the effects of ensuring charging and discharging and cycle-life performance by the electrode active material layer, can be harmonized with each other.

Hereinafter, a method for preparing an electrode assembly according to some example embodiments is described. The method of preparing an electrode assembly includes forming an electrode active material layer on an electrode current collector, introducing a fluorine-based polymer and a nitrile-based polymer into a solvent and mixing the fluorine-based polymer and the nitrile-based polymer to prepare a polymer solution, performing a heat treatment on the polymer solution at a temperature in a range of about 50° C. to about 150° C. for a duration in a range of about 30 minutes to about 3 hours, and electrospinning the polymer solution onto the electrode active material layer.

The above description relates to a method of preparing the electrode assembly according to some example embodiments, and the above description of the electrode assembly may be equally applicable. Accordingly, hereinafter, any redundant portion of the aforementioned description of the electrode assembly is omitted, but the process of preparing the electrode assembly according to some example embodiments is described in detail.

An electrode active material layer is typically formed on an electrode current collector. For example, a slurry for forming the electrode active material layer including an electrode active material is applied on the electrode current collector, and then dried and pressed to form the electrode active material layer. Herein, the slurry for the electrode active material layer may further include a binder, a conductive material, or a combination thereof in addition to the electrode active material, which is described below, and the coating, drying, and pressing methods may be performed by applying general contents in the relevant technical field.

Then, the fluorine-based polymer and the nitrile-based polymer are added to the solvent and mixed to prepare a polymer solution.

For example, the solvent may be or include an organic solvent, and for example, the solvent may include at least one of dimethyl acetate, dimethylformamide, dimethylformaldehyde, dimethyl sulfoxide, N-methylpyrrolidone, ethanol, methanol, chloroform, acetone, water, or a combination thereof.

For example, during the mixing, the fluorine-based polymer and the nitrile-based polymer can be added to the solvent and then stirred.

In some example embodiments, a solute salt may be additionally added to the polymer solution, and then stirred. Accordingly, an electrode assembly exhibiting high heat resistance and shutdown characteristics can be effectively prepared.

For example, the solute salt may be or include a lithium salt, for example, at least one of LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂) (C_{y}F_{2y+1}SO₂) (wherein, x and y are natural numbers, for example, integers from 1 to 20), lithium difluorobisoxalato phosphate, LiCl, LiI, LiB(C₂O₄)₂ (lithium bis(oxalato) borate, LiBOB), lithium difluoro (oxalato) borate (LiDFBOP), lithium difluorobis(oxalato) borate (LiDFBOB), or a combination thereof.

For example, the solute salt may be included in an amount in a range of about 0.05 wt % to about 0.4 wt %, about 0.08 wt % to about 0.3 wt %, or about 0.1 wt % to about 0.3 wt % based on the polymer solute in the polymer solution.

Subsequently, the polymer solution may be heat-treated at a temperature in a range of about 50° C. to about 150° C. for a duration in a range of about 30 minutes to about 3 hours. For example, the heat treatment may be performed at about 55° C. to about 145° C., about 60° C. to about 140° C., or about 70° C. to about 100° C. for about 40 minutes to about 2 hours, about 50 minutes to about 2 hours, or about 1 hour to about 2 hours.

For example, a content of the polymer in the polymer solution may be in a range of about 5 wt % to about 50 wt % based on 100 wt % of a total amount of the solution, for example, about 8 wt % to about 30 wt % or about 10 wt % to about 20 wt %. Within the above ranges, the polymer nanofibers may be effectively formed, and may have a substantially uniform thickness through the electrospinning.

Subsequently, the polymer solution is electrospun onto the electrode active material layer. The electrospinning of the polymer solution may form a coating layer including the polymer nanofibers on the electrode active material layer. Through the electrospinning process, the polymer nanofibers may be assembled to form a woven or non-woven structure, wherein some of the polymer nanofibers are adhered to the electrode active material layer to form the coating layer that the woven or non-woven structure is integrated with the electrode active material layer.

For example, the electrospinning process may be performed by posing a nozzle consisting of or including tips with a predetermined hole size and a roller at a predetermined or desired distance and loading the polymer solution to the tips. Subsequently, after placing the electrode active material layer on the roller, a voltage in a range of about 10 kV to about 120 kV, about 40 kV to about 90 kV, or about 70 kV to about 80 kV may be applied to the tips. The number of the tips may be adjusted according to a type of the polymer included in the polymer solution, a content, and the like, and for example, may be in a range of about 1 to about 200. The predetermined distance between the nozzle pack and the electrode may be in a range of about 5 cm to about 70 cm.

For example, in the electrospinning process, the tips may have a hole size in a range of about 23 GP to about 30 GP (gauge point), for example, 25 GP to 30 GP.

According to the electrospinning process, when the polymer solution is discharged from the end of the tips, as charges are accumulated on the surface of the polymer solution by a high voltage, a cone-shaped Taylor cone is formed. Subsequently, when the surface charges have a larger repulsive force than a drag force (i.e., viscosity+surface tension) of the solution, after a thin jet is ejected from the end of the cone, the polymer nanofibers may be formed through multiaxial drawing in the whipping section.

For example, the electrospinning process may be performed at a temperature in a range of about 18° C. to about 25° C. under a relative humidity in a range of about 0.01% to about 30%, or about 0.01% to about 0.25%. When the electrospinning process is performed under the above temperature and relative humidity conditions, the electrospinning process may have an advantage of forming the polymer nanofibers to have a substantially uniform thickness.

For example, the roller may be adjusted at a roll speed, so that the woven or non-woven structure may have an appropriate or desired thickness, for example, a roll speed in a range of about 0.1 m/min to about 10 m/min, or about 0.1 m/min to about 0.5 m/min. For example, the polymer solution may be adjusted to be discharged from the tips at a flow rate in a range of about 0.01 ml/min to about 100 ml/min.

For example, interference between the tips may be reduced or minimized to achieve substantially uniform electrospinning by controlling tip air as desired. For example, the tip air may be controlled by inflowing compressed air at a pressure in a range of about 0.01 MPa to about 0.8 MPa.

For example, after the electrospinning process, the drying process may be performed with hot air at a temperature in a range of about 70° C. to about 110° C.

In some example embodiments, after the electrospinning process, an inorganic particle solution may be electrosprayed onto the woven or non-woven structure to form an inorganic particle coating layer.

For example, the inorganic particle solution may include at least one of inorganic particles, a binder and a solvent, and the above-described description may be equally applied to the inorganic particles. In the above-mentioned inorganic particle solution, the binder may include at least one of polyvinyl alcohol, polyether, polyvinylidene fluoride, polyamideimide, polyvinylpyrrolidone, polyacrylonitrile, a copolymer thereof, or a combination thereof.

In some example embodiments, in the inorganic particle solution, the solvent may include at least one of dimethyl acetate, dimethylformamide, dimethylformaldehyde, dimethyl sulfoxide, N-methylpyrrolidone, ethanol, methanol, chloroform, acetone, water, or a combination thereof.

For example, in the inorganic particle solution, a content of the inorganic particles may be in a range of about 10 wt % to about 95 wt % based on 100 wt % of a total amount of the inorganic particle solution.

For example, in the electrospraying process of the inorganic particle solution onto the woven or non-woven structure, most of the inorganic particles are accumulated on the surface of the woven or non-woven structure, but some of the inorganic particles may be incorporated into the woven or non-woven structure. Accordingly, the inorganic particles may be distributed with a gradient of gradually decreasing from an upper portion to a lower portion of the woven or non-woven structure.

For example, the electrospray process may be performed by placing a nozzle pack consisting of or including tips with a predetermined hole size and a roller at a predetermined or desired distance, and adding the inorganic particle solution into the tips. Subsequently, after placing the electrode active material layer on the roller, a voltage in a range of about 10 kV to about 100 kV, about 40 kV to about 80 kV, or about 50 kV to about 60 kV, may be applied to the tips. The number of the tips may be adjusted according to a type of an inorganic material included in the inorganic particle solution, a content, and the like, for example, may be in a range of about 1 to about 200. The predetermined or desired distance between the nozzle pack and the electrode may be in a range of about 5 cm to about 70 cm.

For example, in the electrospray process, the tips have a hole size in a range of about 23 GP to about 30 GP (gauge point), for example, about 25 GP to about 30 GP.

For example, the electrospraying process may be performed at a temperature in a range of about 18° C. to about 25° C. under relative humidity in a range of about 0.01% to about 30%, or about 0.01% to about 0.25%. When the electrospraying process is performed under the temperature and relative humidity conditions, it is advantageous to relatively evenly distribute the inorganic particles.

The electrospraying process may disperse the inorganic particle solution onto the electrode active material layer in the form of dots.

In addition, the roller may be adjusted to be set at a speed at which the inorganic particle coating layer may have an appropriate or desired thickness, for example, a speed in a range of about 0.1 m/min to about 10 m/min. Furthermore, the inorganic particle solution may be adjusted to be discharged from the tips at a flow rate in a range of about 10 ml/min to about 100 ml/min.

In addition, interference among the tips may be reduced or minimized to achieve substantially uniform electrospraying by controlling tip air as desired. For example, the tip air may be controlled by inflowing compressed air at a pressure in a range of about 0.01 MPa to about 0.8 MPa.

After the electrospraying process, a drying process may be performed with hot air at a temperature in a range of about 90° C. to about 110° C.

For example, after the electrospray process, a compression process may be performed in order to form the inorganic particle coating layer on the woven or non-woven structure. The thermal compression may increase the inorganic particles mixed into the woven or non-woven structure, and thermally adhere the polymer nanofibers constituting the woven structure. Accordingly, density of the entire coating layer including the woven or non-woven structure and the inorganic particle coating layer may be increased. Accordingly, compared to a coating layer prepared only through the electrospinning process and the electrospray process, when the thermal compression process is further performed, the coating layer may have stronger durability and a thinner thickness, which may resultantly improve energy density.

For example, the thermal compression process may be performed by roll-pressing at a pressure in a range of about 0.01 MPa to about 1 MPa, about 0.05 MPa to about 0.5 MPa, or about 0.1 MPa to about 0.5 MPa; at a temperature in a range of about 80° C. to about 150° C., about 90° C. to about 140° C., or about 100° C. to about 120° C.; at a tensile speed in a range of about 10 cm/min to about 50 cm/min, about 15 cm/min to about 45 cm/min, or about 20 cm/min to about 40 cm/min.

### Rechargeable Lithium Battery

Some example embodiments include a rechargeable lithium battery including the aforementioned electrode assembly. For example, the rechargeable lithium battery may have at least one of the positive and negative electrodes corresponding to the electrode assembly described above, and may further include an electrolyte solution. According to some example embodiments, the rechargeable lithium battery may not include a separate separator.

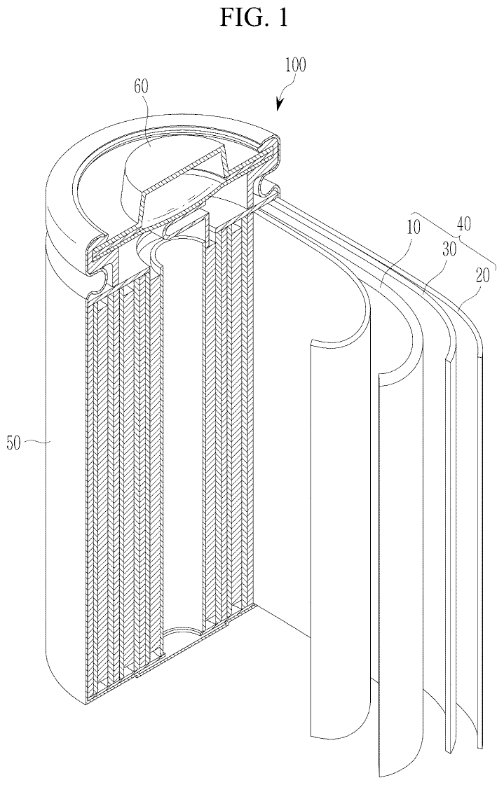

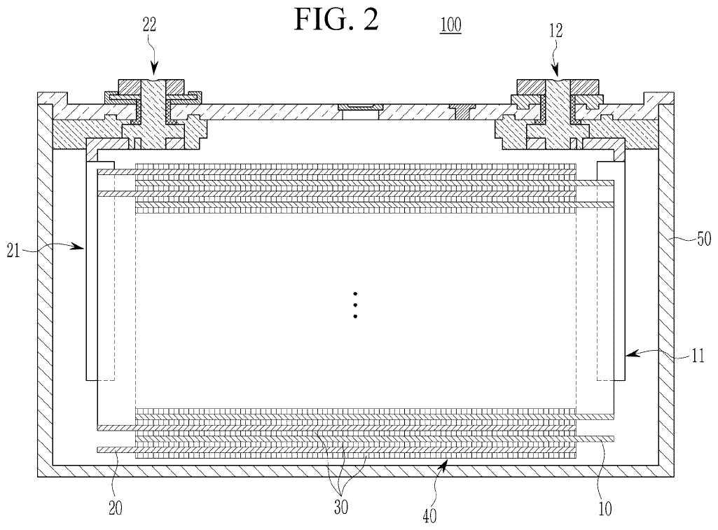

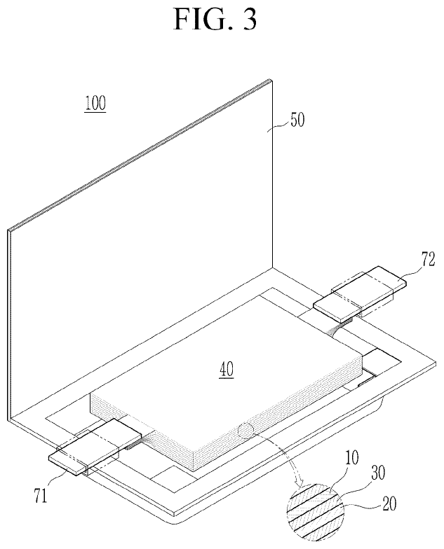

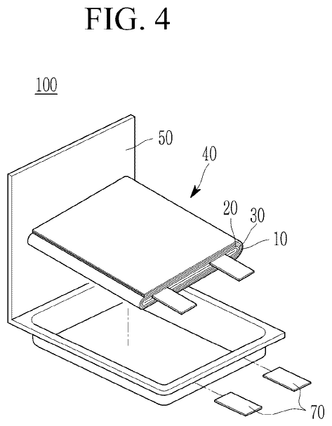

Rechargeable lithium batteries can be classified into cylindrical, square, pouch, and coin types depending on their shape. FIG. 1 to FIG. 4 are schematic views illustrating a rechargeable lithium battery according to some example embodiments. FIG. 1 shows a cylindrical battery, FIG. 2 shows a prismatic battery, and FIG. 3 and FIG. 4 show a pouch battery. Referring to FIG. 1 to FIG. 4, the rechargeable lithium battery 100 may include an electrode assembly 40 with a separator 30 interposed between a positive electrode 10 and a negative electrode 20, and a case in which the electrode assembly 40 is housed therein. The positive electrode 10, negative electrode 20, and separator 30 may be impregnated with an electrolyte solution (not shown). The rechargeable lithium battery 100 may include a sealing member 60 that seals a battery case 50 as shown in FIG. 1. In FIG. 2, the rechargeable lithium battery 100 may include a positive electrode lead tab 11, a positive electrode terminal 12, a negative lead tab 21, and a negative electrode terminal 22. As shown in FIG. 3 and FIG. 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

### Positive Electrode

The positive electrode may include a positive electrode current collector; and a positive electrode active material layer on the positive electrode current collector, wherein the positive electrode active material layer includes a positive electrode active material and may further include at least one of a binder, a conductive material, or a combination thereof.

### Positive Electrode Active Material Layer

The positive electrode active material layer includes a positive electrode active material, and the positive electrode active material may be or include a compound (lithiated intercalation compound) capable of intercalating and deintercalating lithium. For example, the positive electrode active material may be or include at least one of a composite oxide of lithium and a metal such as or including at least one of cobalt, manganese, nickel, and combinations thereof.

The composite oxide may be or include a lithium metal composite oxide, and examples thereof may include at least one of lithium nickel-based oxide, lithium cobalt-based oxide, lithium manganese-based oxide, lithium iron phosphate, cobalt-free lithium nickel-manganese-based oxide, lithium-manganese-rich oxide, or a combination thereof.

As another example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8)

In the above chemical formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; Q is or includes at least one of Ti, Mo, Mn, or a combination thereof; Z is or includes at least one of Cr, V, Fe, Sc, Y, or a combination thereof; and L¹ is or includes at least one of Mn, Al or a combination thereof.

For example, the positive electrode active material may include a cobalt-based positive electrode active material having a cobalt content that is greater than or equal to about 30 mol %, greater than or equal to about 50 mol %, or greater than or equal to about 80 mol % based on 100 mol % of metal excluding lithium in a lithium metal composite oxide.

As another example, the positive electrode active material may include a high-nickel positive electrode active material having a nickel content that is greater than or equal to about 80 mol % based on 100 mol % of metal excluding lithium in a lithium metal composite oxide. A nickel content in the high-nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium. The high-nickel positive electrode active material can realize high capacity and can be applied to high-capacity, high-density rechargeable lithium batteries.

In the positive electrode active material layer, the binder is configured to attach positive electrode active material particles to each other and also to attach positive electrode active material to adjacent layers. Examples of binders may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

In the positive electrode active material layer, the conductive material is included to provide electrode conductivity, and any electrically conductive material may be included as a conductive material unless the electrically conductive material causes a chemical change in the battery. Examples of the conductive material may include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

In the positive electrode active material layer, the contents of the binder and the conductive material may be in a range of about 0.5 wt % to about 5 wt %, respectively, based on 100 wt % of the positive electrode active material layer.

For example, the thickness of the positive electrode active material layer may be in a range of about 2 μm to about 150 μm, for example about 5 μm to about 140 μm, about 10 μm to about 130 μm, or about 20 μm to about 120 μm.

The positive electrode collector may be made of or include, but is not limited to, Al, stainless steel (SUS), or a combination thereof.

### Negative Electrode

The negative electrode may include a negative electrode current collector; and a negative electrode active material layer on the negative electrode current collector, and the negative electrode active material layer may include a negative electrode active material and may further include a binder, a conductive material, or a combination thereof.

### Negative Electrode Active Material

The negative electrode active material includes a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is an element such as or including at least one of an alkali metal, an alkaline-earth metal, a Group 13 element, a Group 14 element (excluding Si), a Group 15 element, a Group 16 element, a transition metal, a rare earth element, and a combination thereof, for example Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, in a range of about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon, hard carbon, a mesophase pitch carbonized product, and calcined coke.

When the silicon-carbon composite includes silicon and amorphous carbon, a silicon content may be in a range of about 10 wt % to about 50 wt %, and a content of amorphous carbon may be in a range of about 50 wt % to about 90 wt % based on 100 wt % of the silicon-carbon composite. In addition, when the composite includes silicon, amorphous carbon, and crystalline carbon, a silicon content may be in a range of about 10 wt % to about 50 wt %, a content of crystalline carbon may be in a range of about 10 wt % to about 70 wt %, and a content of amorphous carbon may be in a range of about 20 wt % to about 40 wt % based on 100 wt % of the silicon-carbon composite.

For example, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may be in the form of silicon alone, in the form of a silicon alloy, or in an oxidized form. The oxidized form of silicon may be represented by SiOₓ (0<x≤2). For example, the atomic content ratio of Si:O, which indicates a degree of oxidation, may be in a range of about 99:1 to about 33:67. As included herein, when a definition is not otherwise provided, an average particle diameter (D₅₀) indicates a diameter of a particle where an accumulated volume is equal to about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio may be a weight ratio in a range of about 1:99 to about 90:10.

### Binder

The binder is configured to adhere the negative electrode active material particles to each other, and to adhere the negative electrode active material to the current collector. The binder may be or include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity, and any electrically conductive material may be included as a conductive material unless the electrically conductive material causes a chemical change in the battery. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

A content of the negative electrode active material may be in a range of about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be or include an electrolyte solution, which may include a non-aqueous organic solvent and a lithium salt.

The non-aqueous organic solvent is configured as a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be included alone or in a mixture of two or more types of solvent, and when two or more types of solvent are included in a mixture, a mixing ratio can be adjusted as desired according to the desired battery performance, which is known to those working in the field.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed in a volume ratio in a range of about 1:1 to about 30:1.

The electrolyte solution may further include at least one of vinylethyl carbonate, vinylene carbonate, and an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, enables a basic operation of a rechargeable lithium battery, and improves transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOB), and lithium bis(oxalato) borate (LiBOB).

A concentration of lithium salt may be within the range of about 0.1 M to about 2.0 M. When the concentration of lithium salt is within the above range, the electrolyte solution has an appropriate or desired ionic conductivity and viscosity, and thus desired or improved performance can be achieved and lithium ions can move effectively.

### Separator

As described above, the rechargeable lithium battery according to some example embodiments may not include a separate separator.

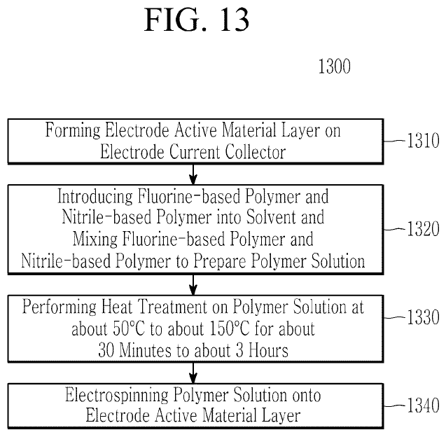

FIG. 13 is a flowchart illustrating a method of preparing an electrode assembly, according to an example embodiment. In FIG. 13, the method 1300 includes operation 1310 which includes forming an electrode active material layer on an electrode current collector. Operation 1320 includes introducing a fluorine-based polymer and a nitrile-based polymer into a solvent and mixing the fluorine-based polymer and the nitrile-based polymer to prepare a polymer solution. Operation 1330 includes performing a heat treatment on the polymer solution at a temperature in a range of about 50° C. to about 150° C. for a duration in a range of about 30 minutes to about 3 hours. Operation 1340 includes electrospinning the polymer solution onto the electrode active material layer.

Examples and comparative examples of the present disclosure are described below. However, the following examples are only examples of the present disclosure, and the present disclosure is not limited to the following examples.

### Example 1

### (1) Preparing of Electrode Assembly (Negative Electrode Assembly)

### 1) Formation of Negative Electrode Active Material Layer

97.5 wt % of an artificial graphite negative electrode active material, 1 wt % of carboxy methyl cellulose (CMC), and 1.5 wt % of a styrene butadiene rubber (SBR) were mixed in a water solvent to prepare a slurry for a negative electrode active material layer. The slurry for a negative electrode active material layer was coated on a copper foil current collector, and then dried and pressed to prepare a negative electrode having a negative electrode active material layer on the negative electrode current collector.

### 2) Electrospinning

Subsequently, a polymer solution was prepared by adding polyvinylidene fluoride (Mw: 495,000 g/mol, Tg:−37° C.) and polyacrylonitrile (Mw: 85,000 g/mol, Tg: 93° C.) in a weight ratio of 7:3 to a solvent of dimethyl acetate to have a solid content of 16 wt %, additionally adding 0.1 wt % of LiCl based on that of the polymer solute, and then stirring the mixture and heat-treating it at 70° C. for 1 hour.

The polymer solution was electrospun onto the negative electrode active material layer, and then dried with hot air at 90° C. Herein, the electrospinning process was performed by positioning a nozzle pack consisting of tips with a hole size of 25 GP and a roller at a distance of 15 cm, injecting the polymer solution into the tips, applying thereto a voltage of 70 kV to 80 KV at 20° C. under relative humidity of 0.01%. Herein, after setting the roller at a speed of 0.1 m/min to 0.5 m/min and discharging the polymer solution from the tips at a flow rate of 1 ml/min, the electrospinning process was performed by flowing compressed air at a pressure of 0.3 MPa.

Through the electrospinning process, a non-woven fabric structure was formed by assembling polymer nanofibers included in a coating layer located on the negative electrode active material layer and integrated with the negative electrode active material layer. Herein, the polymer nanofibers had a diameter of 90 nm, and the non-woven fabric structure had a thickness of 20 μm.

### 3) Electric Spraying

Subsequently, an inorganic particle solution was prepared to have a solid of 20 wt % by mixing alumina (D₅₀=250 nm) and a binder in a weight ratio of 20:1 in a mixed solvent of water and ethanol in a weight ratio of 6:4. Herein, the binder was a mixed binder of polyvinyl alcohol and polyether.

The inorganic particle solution was electrosprayed onto the non-woven fabric structure. The electrospraying process was performed by using a nozzle pack consisting of tips with a hole size of 25G and a roller at a distance of 15 cm, adding the inorganic particle solution to the tips, applying a voltage of 50 kV to 60 kV thereto, electrospraying the inorganic particle solution at 20° C. under relative humidity of 0.01%, and drying the inorganic particle solution with hot air at 90° C. Herein, the connecting roller was set at a speed of 0.1 m/min to 0.5 m/min, and the inorganic particle solution was set to be discharged at a flow rate of 20 ml/min. In addition, the electrospraying process was performed by flowing compressed air at a pressure of 0.3 MPa.

Accordingly, an inorganic particle coating layer (a thickness: 23 μm) including alumina (D₅₀=250 nm) was formed on the non-woven fabric structure.

Herein, the polymer nanofibers were adjusted to be 50 wt % based on 100 wt % of the coating layer, while the inorganic particles were adjusted to be 50 wt %.

### 4) Heat Pressing

After sequentially performing the electrospinning and electrospraying process, a thermal compression process was performed at a pressure of 0.2 MPa, at 100° C., and at a tensile speed of 30 cm/min. Finally, an electrode assembly was obtained.

In the finally obtained electrode assembly, the coating layer had a total thickness of 11 μm and exhibited a gradient that the inorganic particles were gradually less distributed from an upper portion to a lower portion of the coating layer.

### (2) Manufacturing of Positive Electrode

96 wt % of LiCoO₂, 2 wt % of ketjen black, and 2 wt % of polyvinylidene fluoride were mixed in an N-methyl pyrrolidone solvent to prepare a slurry for a positive electrode active material layer. The slurry for a positive electrode active material layer was coated on an aluminum foil current collector, and then dried and pressed to form an about 30 μm-thick positive electrode active material layer, thereby preparing a positive electrode.

### (3) Manufacturing of Rechargeable Lithium Battery Cell

The coating layer of the electrode assembly (negative electrode assembly) and the positive electrode were stacked to contact each other, and an electrolyte solution was injected thereinto to prepare a rechargeable lithium battery cell. The electrolyte solution was prepared by mixing ethylene carbonate and dimethyl carbonate in a volume ratio of 3:7 and dissolving 1 M LiPF₆ in the mixed solvent.

### Example 2

An electrode assembly and a rechargeable lithium battery cell were prepared substantially in the same manner as in Example 1, with a difference that the polymer solution was prepared by changing the solid content to 15.5 wt %.

### Example 3

An electrode assembly and a rechargeable lithium battery cell were prepared substantially in the same manner as in Example 1, with a difference that the polymer solution was prepared by changing the solid content to 15 wt %.

### Example 4

An electrode assembly and a rechargeable lithium battery cell were prepared substantially in the same manner as in Example 1, with a difference that the polymer solution was prepared by changing the solid content to 14 wt %.

### Comparative Example 1

An electrode assembly and a rechargeable lithium battery cell were prepared substantially in the same manner as in Example 1, with a difference that the polymer solution was prepared by changing the solid content to 10 wt % and adding 0.5 wt % of LiCl based on the polymer solute thereto.

### Comparative Example 2

An electrode assembly and a rechargeable lithium battery cell were prepared substantially in the same manner as in Example 1, with a difference that the polymer solution was prepared by adding 14 wt % of polyamic acid instead of the polyvinylidene fluoride and the polyacrylonitrile.

### Comparative Example 3

An electrode assembly and a rechargeable lithium battery cell were prepared substantially in the same manner as in Example 1, with a difference that the polymer solution was prepared by adding 10 wt % of LiCl based on the polymer solute thereto.

### Comparative Example 4

An electrode assembly and a rechargeable lithium battery cell were prepared substantially in the same manner as in Example 1, with a difference that the polymer solution was prepared by changing the solid content to 10 wt % and adding 2 wt % of LiCl based on the polymer solute thereto.

### Comparative Example 5

A rechargeable lithium battery cell was prepared substantially in the same manner as in Example 1, with a difference that the electrode assembly was not prepared, but a polyethylene-based multi-layered coating separator containing a ceramic layer and an adhesive layer (a thickness: 13 μm, Asahi Kasei Corp.) and an electrolyte solution prepared by dissolving 1 M LiPF₆ in a mixed solvent of ethylene carbonate and dimethyl carbonate in a volume ratio of 3:7 were used, and the positive electrode, the separator, and the negative electrode were stacked together.

### Evaluation Example 1: Evaluation of Dielectric Constant and Electrical Conductivity

The polymer solutions according to Examples 1 to 4 and Comparative Examples 1 to 4 were measured with respect to dielectric constant and electrical conductivity, and the results are shown in Table 1 below. Herein, the dielectric constant and electrical conductivity were measured by placing the polymer solutions for electrospinning with a predetermined volume at room temperature under a normal pressure between upper and lower plates of a rheometer and using an LCR meter within a range of 50 Hz to 100,000 Hz. Each of the samples was three times measured and then, averaged to obtain the dielectric constant and the electrical conductivity at 50,000 Hz, which has a similar time scale to the time scale of the electrospinning.

TABLE 1

| | Dielectric | Electrical |
|---|---|---|
| | constant | conductivity |
| | [pF/mm³] | [μS/mm³] |
| Example 1 | 0.1 | 10.0 |
| Example 2 | 0.09 | 9.0 |
| Example 3 | 0.08 | 8.0 |
| Example 4 | 0.07 | 7.0 |
| Comparative Example 1 | 0.04 | 20 |
| Comparative Example 2 | 0.06 | 0.5 |
| Comparative Example 3 | 0.1 | 70 |
| Comparative Example 4 | 0.05 | 40 |

Referring to Table 1 above, the polymers of Examples 1 and 4 exhibited a dielectric constant that is greater than or equal to 0.06 pF/mm³, and an electrical conductivity that is 3.0 μS/mm³ to 50.0 μS/mm³.

On the contrary, the polymers of Comparative Examples 1 to 4 showed that the dielectric constant or the electrical conductivity did not meet the above ranges.

### Evaluation Example 2: Electrospinning Evaluation

Whether or not the polymer solutions of Examples 1 to 4 and Comparative Examples 1 to 4 formed a non-woven fabric structure by assembling polymer nanofibers therein through the electrospinning process was evaluated.

Referring to the evaluation results, in Examples 1 to 4, the electrospinning process was possible, so the non-woven fabric structure was formed by assembling the polymer nanofibers.

On the contrary, in Comparative Examples 1 to 3, the electrospinning process was impossible, so the non-woven fabric structure was not formed by assembling the polymer nanofibers.

However, when the polymer solution of Comparative Example 4 was subjected to the electrospinning process, polymer nanofibers formed through the electrospinning were assembled to form the non-woven fabric structure. Accordingly, in the electrode assembly of Comparative Example 4, it was possible to form a coating layer having a mixed structure of the non-woven fabric structure formed by assembling a large number of polymer fibers through the electrospinning and a small number of polymer dots formed through the electrospraying process.

### Evaluation Example 3: Evaluation of Thermal Safety

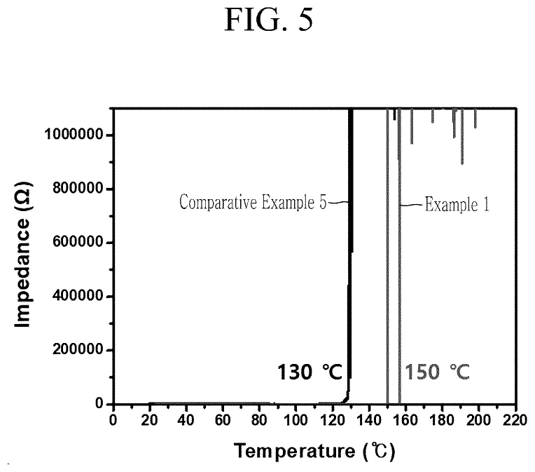

Symmetry cells respectively including the coating layer of Example 1 and the separator of Comparative Example 5 were measured with respect to impedance changes, while heating to 220° C. at 10° C./min, and the results are shown in FIG. 5.

Referring to FIG. 5, the impedance significantly increased during shutdown, wherein Comparative Example 5 using a general separator exhibited a significant increase in the impedance at 130° C., but Example 1 using the electrode assembly according to some example embodiments exhibited a significant increase in the impedance at 150° C., which confirmed that Example 1, in which the shutdown occurred at a higher temperature than in Comparative Example 5, exhibited more desired or improved thermal safety.

Accordingly, when using the electrode assembly as in Example 1, it was confirmed to be applied at a higher temperature in the subsequent process.

### Evaluation Example 4: Evaluation of Shutdown Performance

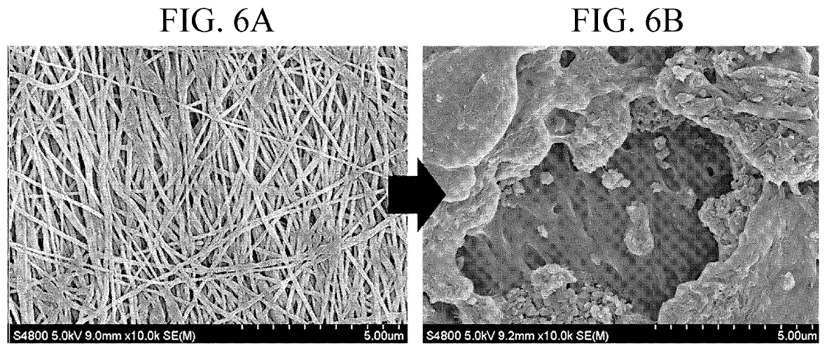

After the shutdown in Evaluation Example 1, an image of the coating layer of the electrode assembly of Example 1 was taken with a scanning electron microscope (SEM), which is shown in FIG. 6A and FIG. 6B.

FIG. 6A shows an image of the polymer nanofibers in the coating layer of the electrode assembly before the shutdown and FIG. 6B shows an image of some melted polymer nanofibers in the coating layer of the electrode assembly after the shutdown. Referring to FIG. 6A and FIG. 6B, pores in the coating layer were shielded in FIG. 6B, which confirmed that the shutdown function was effectively expressed.

### Evaluation Example 5: Evaluation of Dry Heat Shrinkage

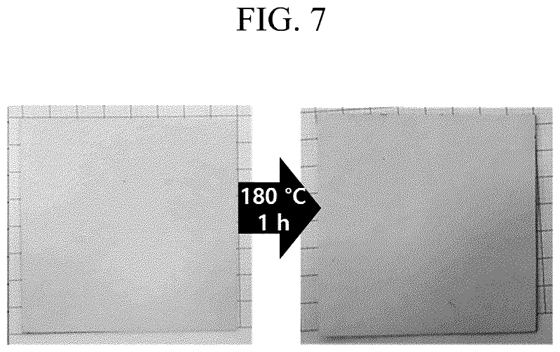

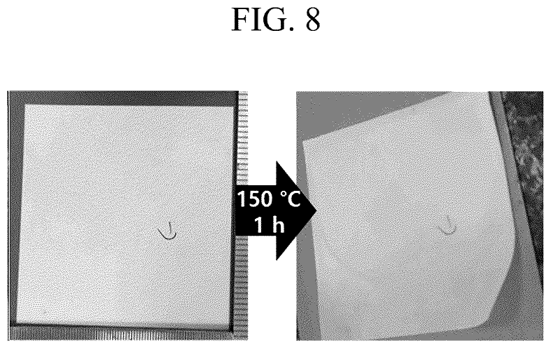

The electrode assembly of Example 1 was heat-treated at 180° C. for 1 hour under dry conditions without electrolyte solution impregnation, and an image thereof was taken, which is provided in FIG. 7. Similarly, the separator used in Comparative Example 5 was heat-treated at 150° C. for 1 hour, and an image thereof was taken, which is provided in FIG. 8.

Referring to FIG. 7 and FIG. 8, the electrode assembly of Example 1 exhibited shrinkage rates of 0%/0% in MD/TD directions after the heat treatment under the dry conditions, which confirmed that no thermal shrinkage occurred, but the separator used in Comparative Example 5 exhibited shrinkage ratio rates of 0.7%/1.25% in the MD/TD directions after the heat treatment under the dry conditions, which confirmed that thermal shrinkage occurred.

### Evaluation Example 6: Evaluation of Wet Heat Shrinkage

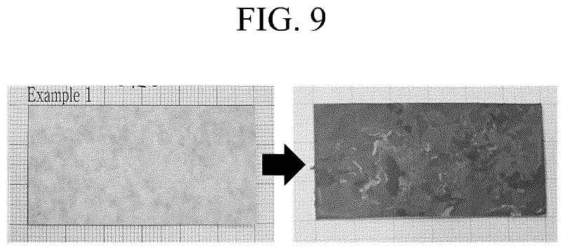

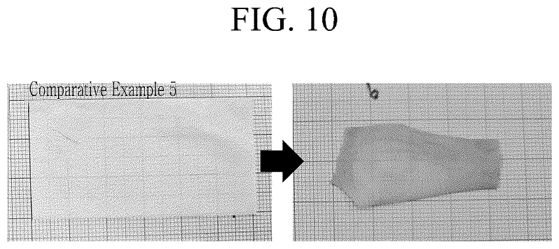

The electrode assembly of Example 1 was heat-treated at 150° C. for 1 hour under wet conditions of being immersed in an electrolyte solution, and an image thereof was taken, which is provided in FIG. 9. Similarly, the separator used in Comparative Example 5 was heat treated at 150° C. for 1 hour, and an image thereof was taken, which is provided in FIG. 10.

Referring to FIG. 9 and FIG. 10, the electrode assembly of Example 1, which was heat-treated under the wet condition, exhibited thermal shrinkage rates of 0%/0% in the MD/TD directions, which confirmed no thermal shrinkage, but the separator used in Comparative Example 5 exhibited thermal shrinkage rates of 23%/45% in the MD/TD directions after the heat treatment under the wet conditions, which confirmed that heat shrinkage occurred.

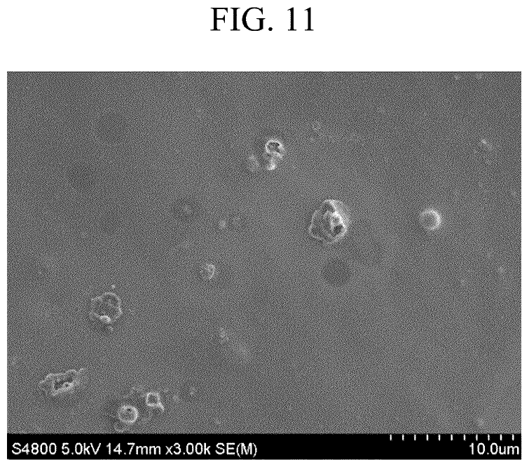

In addition, an image of the surface of the electrode assembly of Example 1 was taken after the wet heat shrinkage test with a scanning electron microscope (SEM), which is provided in FIG. 11. Referring to FIG. 11, the polymer nanofibers in the coating layer were confirmed to be completely melted on the surface of the electrode assembly. Accordingly, the pores in the coating layer of the electrode assembly were shielded, which performed a shutdown function.

### Evaluation Example 7: Heat Exposure Evaluation

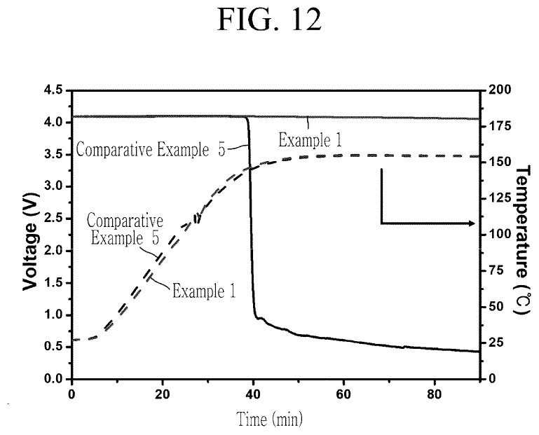

Each of the rechargeable lithium battery cells with 2 Ah capacity of Example 1 and Comparative Example 5 was charged to 4.2 V and heat-treated at 150° C. for 1 hour, and then measured with respect to voltage and temperature changes over time, and the results are shown in FIG. 12.

Comparative Example 5 exhibited a voltage drop due to a short circuit by the heat treatment at 146° C., but Example 1 did not exhibit the short circuit and the voltage drop.

### Evaluation Example 8: Evaluation of Initial Charging and Discharging Capacity and Efficiency

The rechargeable lithium battery cells of Examples 1 to 4 and Comparative Examples 4 and 5 were charged to an upper limit voltage of 4.25 V at a constant current of 0.1 C and to 0.05 C at the constant voltage, and then discharged to a cut-off voltage of 2.8 V at 0.1 C at 25° C. to proceed with initial formation.

Table 2 below shows the initial charge capacity, initial discharge capacity, and the ratio of the latter to the former, which was calculated as efficiency.

TABLE 2

| | 33 C charge | 33 C discharge | Efficiency |
|---|---|---|---|
| | (mAh/g) | (mAh/g) | (%) |
| Example 1 | 2100 | 2089 | 99.4 |
| Example 2 | 2100 | 2077 | 98.9 |
| Example 3 | 2100 | 2045 | 97.4 |
| Example 4 | 2100 | 2011 | 95.8 |
| Comparative Example 4 | 1000 | 0 | 0 |
| Comparative Example 5 | 2100 | 2089 | 99.4 |

Referring to Table 2, Examples 1 to 4 were confirmed to exhibit initial charging and discharging efficiency at the same level as Comparative Example 5.

### Evaluation Example 9: Evaluation of Cycle-life Performance

After the initial charging and discharging of Evaluation Example 8, the cells were 50 cycles or more charged and discharged at 1.0 C within a voltage range of 3.0 V to 4.45 V at 25° C. to calculate a ratio of 50th cycle discharge capacity to the initial discharge capacity, and the results are shown in Table 3 below.

TABLE 3

| | 50^{th} capacity retention rate (%) |
|---|---|
| Example 1 | 98.6 |
| Example 2 | 98.4 |
| Example 3 | 97.1 |
| Example 4 | 94.3 |
| Comparative Example 4 | 0 |
| Comparative Example 5 | 97.9 |

Referring to Table 3, Examples 1 and 2 were confirmed to exhibit a high 50th capacity retention rate, and thus desired or improved cycle-life performance, compared to Comparative Examples 4 and 5.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. An electrode assembly, comprising:
an electrode current collector;
an electrode active material layer on the electrode current collector; and
a coating layer located on the electrode active material layer and integrated with the electrode active material layer; wherein:
the coating layer includes polymer nanofibers,
the polymer nanofibers include a fluorine-based polymer and a nitrile-based polymer as a polymer,
a dielectric constant of the polymer is greater than or equal to about 0.06 pF/mm³, and
an electrical conductivity of the polymer is in a range of about 3.0 μS/mm³ to about 50.0 μS/mm³.

2. The electrode assembly as claimed in claim 1, wherein the coating layer comprises one of a woven structure and a non-woven structure formed by assembling the polymer nanofibers in the above coating layer.

3. The electrode assembly as claimed in claim 1, wherein the fluorine-based polymer comprises at least one of polyvinylidene fluoride, polyvinylidene fluoride-hexafluoropropylene, polyvinyl fluoride, and polytetrafluoroethylene.

4. The electrode assembly as claimed in claim 1, wherein a weight average molecular weight of the fluorine-based polymer is in a range of about 100,000 g/mol to about 1,500,000 g/mol.

5. The electrode assembly as claimed in claim 1, wherein a glass transition temperature of the fluorine-based polymer is in a range of about −80° C. to about −5° C.

6. The electrode assembly as claimed in claim 1, wherein the nitrile-based polymer comprises at least one of polyacrylonitrile, polyacrylonitrile-itaconic acid, polyacrylonitrile-methyl methacrylate, polyacrylonitrile-acrylic acid, polyacrylonitrile-methacrylate, and a (meth)acrylonitrile-butadiene rubber.

7. The electrode assembly as claimed in claim 1, wherein a weight average molecular weight of the nitrile-based polymer is in a range of about 10,000 g/mol to 1,500,000 g/mol.

8. The electrode assembly as claimed in claim 1, wherein a glass transition temperature of the nitrile-based polymer is in a range of about −80° C. to about 180° C.

9. The electrode assembly as claimed in claim 1, wherein a weight ratio of the fluorine-based polymer to the nitrile-based polymer is in a range of about 1:9 to about 9:1.

10. The electrode assembly as claimed in claim 1, wherein a diameter of the polymer nanofibers is in a range of about 10 nm to about 1,000 nm.

11. The electrode assembly as claimed in claim 1, wherein the coating layer further comprises inorganic particles.

12. The electrode assembly as claimed in claim 11, wherein the inorganic particle comprises at least one of Al₂O₃, SiO₂, TiO₂, SnO₂, CeO₂, MgO, NiO, CaO, GaO, ZnO, ZrO₂, Y₂O₃, SrTiO₃, BaTiO₃, and Mg(OH)₂, boehmite.

13. The electrode assembly as claimed in claim 11, wherein an average particle diameter (D₅₀) of the inorganic particles is in a range of about 10 nm to about 1,000 nm.

14. The electrode assembly as claimed in claim 11, wherein:
the polymer nanofibers are included in an amount in a range of about 10 wt % to about 100 wt % based on 100 wt % of the coating layer, and
the inorganic particles are included in an amount that is less than or equal to about 90 wt % based on 100 wt % of the coating layer.

15. The electrode assembly as claimed in claim 1, wherein a thickness of the coating layer is in a range of about 5 μm to about 40 μm.

16. The electrode assembly as claimed in claim 1, wherein a ratio of the thickness of the coating layer to the thickness of the electrode active material layer is in a range of about 1:1 to about 1:50.

17. The electrode assembly as claimed in claim 1, wherein the coating layer further comprises:
one of a woven structure and a non-woven structure formed by assembling the polymer nanofibers in the coating layer; and
an inorganic particle coating layer including inorganic particles.

18. The electrode assembly as claimed in claim 11, wherein a distribution of the inorganic particles gradually decreases from an upper portion to a lower portion of the coating layer.

19. A method of preparing an electrode assembly, the method comprising:
forming an electrode active material layer on an electrode current collector,
introducing a fluorine-based polymer and a nitrile-based polymer into a solvent and mixing the fluorine-based polymer and the nitrile-based polymer to prepare a polymer solution,
performing a heat treatment on the polymer solution at a temperature in a range of about 50° C. to about 150° C. for a duration in a range of about 30 minutes to about 3 hours, and
electrospinning the polymer solution onto the electrode active material layer.

20. A rechargeable lithium battery comprising the electrode assembly as claimed in claim 1.
